(19) United States
(12) Patent Application Publication
(10) Pub. No.: US 2001/0052188 A1
(43) Pub. Date: Dec. 20, 2001

(54) Holding device for a sharpener

(76) Inventor: Fritz Luttgens, Erlangen (DE)

Correspondence Address: VENABLE, BAETJER, HOWARD and CIVILETTI, LLP, P.O. Box 34385, Washington, DC, 20043-9998, US

(21) Appl. No.: 09/769,283

(22) Filed: Jan. 26, 2001

(30) Foreign Application Priority Data
Jan. 27, 2000 (DE) 100 043 433.0

(51) Int. Cl. B43L 23/00

(52) U.S. Cl. 30/454; 30/451

(57) ABSTRACT

The holding device for a pencil sharpener (8) is a molded body (21), which can be fitted so as to be detachable from one pencil end (7, 13) onto a pencil, in the manner of a cap (17) that grips around the pencil shaft (4). It contains or consists of a rubber-elastic material and is furthermore provided with a holding projection (20), which can be inserted frictionally adhering, but detachable, into the pencil guiding channel (9) of the sharpener (8) (FIG. 1).

The invention relates to a device with the features as listed in the preamble to claim 1. The essential component of a pencil to be sharpened is the centrally positioned lead, which is surrounded by a peelable material to prevent the user hand from getting dirty. Traditionally, this material consists primarily of a peelable wood, a paper sleeve or the like. The lead diameter for pencils of this type differs, depending on the use. The pencil lead is subjected to permanent wear when the pencil is used, which causes a dulling of the lead tip and changes the general impression of the handwriting. The pencil is sharpened at regular intervals with a sharpener to regenerate the pencil tip. It is therefore advantageous for the pencil user if the pencil or lead sharpener is always close at hand, so that it can be grasped easily.

The traditionally used sharpeners are simple mass-produced articles of different designs. However, sharpeners of this type are similar with respect to one design feature. They comprise a peeling blade that flanks the conical end of the pencil-guiding channel for a conical peeling of the pencil end to be sharpened. The sharpening above all serves to achieve the desired sharpening and shaping of the lead with conical tapering in the surface area toward the writing end.

It is the object of the invention to create a universally usable device, which puts the sharpener, necessary for a regular regeneration of the pencil tip, within grasping distance of the pencil user. This object is solved with claim 1.

The device according to the invention is an adapter, which can be fitted or slid easily, but non-loosening, onto the pencil end that is not needed for the defined use of the pencil. The device holds the sharpener there in a non-loosening way, but such that it can be removed for use. The rubber-elastic contracting ability of the material used for the device, as well as the friction coefficient that enhances the adhering ability allow the device to be attached non-loosening to the back end of the pencil while, at the same time, allowing it to be detached easily. The cap or sleeve that is fitted onto the pencil end, for example, can therefore also be adapted easily and automatically to the different peripheral outlines of the pencil. To be sure, it is standard practice to provide pencils not only with a cylindrical peripheral shape. Shaft cross sections with primarily a unilateral hexagonal or elliptical design are also standard and irregular cross sectional shapes can frequently be found as well. It should be possible to use the device according to the invention independent of the cross-sectional shape of the pencil shaft, which is also made possible by the rubber-type elasticity and contraction ability of the material used for the device.

The traditional conical shape of the standard sharpening-channel that is tapered toward the end favors the fixation of the sharpener on the holding projection for the device according to the invention, so as to be easily detachable as well as non-loosening. As a result, the holding projection fits numerous standard sharpeners, regardless of its peripheral shape. It is not important at which axial position of the sharpening channel, which is conically tapered toward its tip or its insertion end, the desired frictional connection is created. Important is only that such a frictional connection is created, and the rubber-elastic consistency of the material for the device supports this purpose. At the clamping location, it ensures the necessary pressure for clamping on or adhering and guarantees that the desired frictional effect is mostly independent of the peripheral shape of the holding projection. As a result of the segment-type division of the holding projection, the radial spring behavior of the holding projection can easily be influenced and varied. The segments of the projection act in the manner of expanding jaws of an expanding chuck upon the outer surfaces of the peeling cone for the pencil guide channel of the sharpener and adapt even better to varied sharpener designs, particularly their sharpening channels.

Characteristics of the device, which are listed in the dependent claims, further increase the frictional effect.

One exemplary embodiment of the device according to the invention is described with the aid of the exemplary embodiments shown in the Figures, which show in:

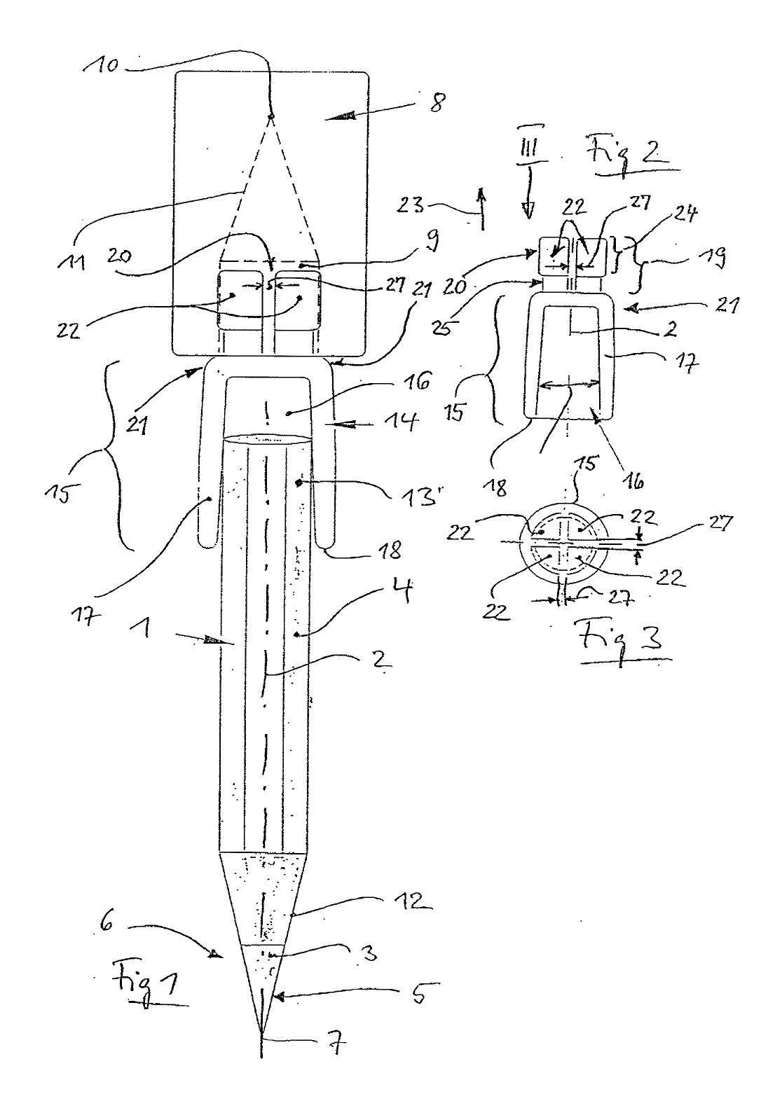

FIG. 1 An enlarged total view of a pencil with fitted-on connecting device—in part as sectional cut—and a sharpener held by this device.

FIG. 2 A view from the side—in part as a sectional cut—of the holding device according to the invention.

FIG. 3 A view from above of the holding device in arrow direction III, as shown in FIG. 2.

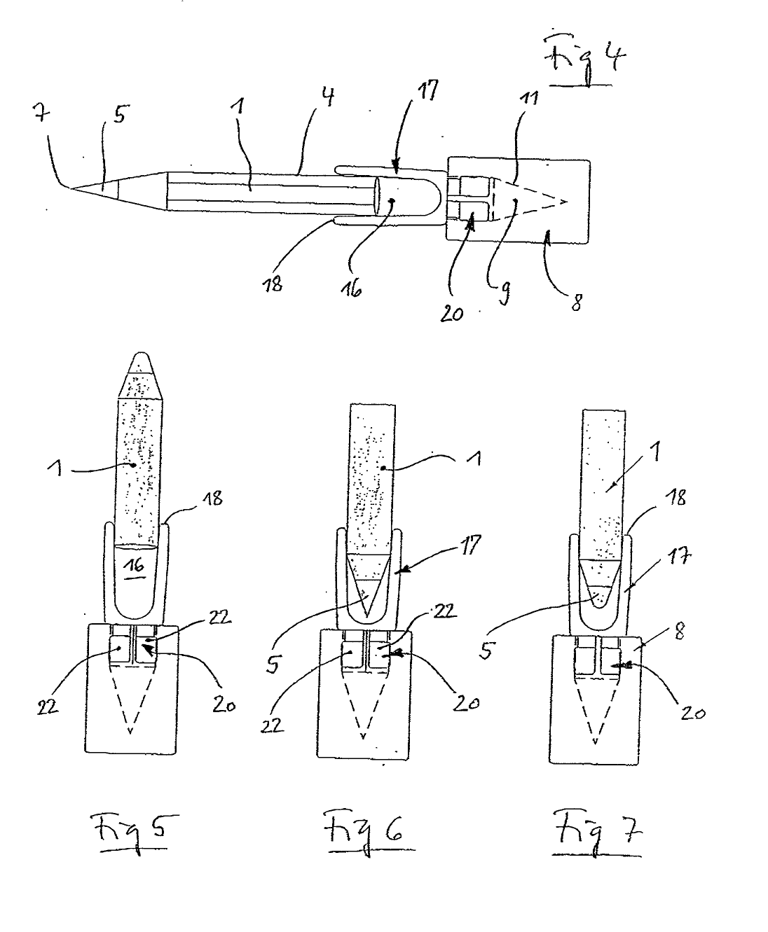

FIG. 4 A reduced side view analog to FIG. 1.

FIGS. 5 to 7 Differing views from the side, analog to FIG. 4, of pencils with a fitted-on holding device and a sharpener placed onto the holding device.

The pencil 1 contains a pencil lead 3 that is positioned concentric to its longitudinal axis 2. For a better gripping hold and protection against contact, the pencil lead is also surrounded concentric to the longitudinal axis 2 by an enveloping jacket 4 of a peelable material, for example wood, cardboard or a corresponding plastic. The tip 5 of pencil lead 3 projects in the front from the enveloping jacket 4. The writing end 6 on the front of pencil 1 is conically tapered in the direction of the frontal end of lead 7. A handheld sharpener with reference 8 is used for sharpening the writing end 6 or the lead end 7 in each case. This type of sharpener is mass-produced and can be obtained commercially. Its general functional principle is known, for example, from German Patent 3004020. One essential feature of this sharpener 8, which is shown only with dashed lines herein (FIG. 1), is its pencil guiding channel 9, which is conically tapered in the direction of its inside end 10. A peeling blade that is not shown in further detail here flanks the cone-shaped jacket 11 of the guiding channel and shapes the pencil cone 12 by cutting it over the complete axial length. For this, the pencil 1 is manually turned inside the the housing for sharpener 8, which is designed to be stationary.

A holding device with reference 14 can be fitted onto the back end 13 of the enveloping jacket 4 that is facing away from the lead end 7. On the side 15 where the holding device is fitted on and is facing the lead tip 5 when in the fitted on position, the holding device is provided with a cap or sleeve 17 that surrounds the insertion opening 16 and has an opening edge 18, which faces the lead tip 5 when the cap is fitted on (FIGS. 1, 4, 6 and 7).

On the holding side 19 that faces away from the fitting-on side 15, the holding device is provided with a holding projection 20 for the detachable frictional engagement in the pencil guiding channel 9 of sharpener 8. The holding device is a one-piece molded body 21 (FIGS. 2, 3). The holding projection 20 comprises four equally large and preferably identical projection segments 22, positioned side-by-side in the manner of fasces rods. They are identical in size and design and are positioned at a distance to each other, radial to the projection direction 23 of the longitudinal axis 2 of molded body 21 (distance gap 27 in FIGS. 1 to 3). When the cap 17 is fitted onto the writing end 6 that is associated with the lead tip 5, it is surrounded by a hollow space, which seals the exposed lead tip 5 relative to the surrounding atmosphere. As a result, little or no fumes from the lead tip 5 can reach the surrounding air. In addition, the lead tip 5 is protected in this way against drying out. With their outer periphery, the projection segments 22 represent portions of a peripheral jacket, in particular a cylindrical covering, which concentrically surrounds the longitudinal axis 2 of molded body 21 and thus also the holding projection 20.

Between its outer expanding-fixation region 24 and the end 15 for fitting on, the holding projection 20 is provided with an area 25 that narrows down in radial direction. The inside diameter 26 of the opening 16 for fitting on or slipping on the holding sleeve 17 diverges slightly from its inside end in the direction toward the end facing the fitting-on opening 16. The fitting-on opening 16 is surrounded by the opening edge 18.

On additional modified feature is the use of eraser material as material for the molded body 21. The molded body 21 in that case can function as eraser, as well as meet its holding function. The holder satisfactorily meets this eraser function, which can be used in addition or at least as required, without reducing its holding function, particularly if it is not used too often and too intensively.

### Reference Number List

1 pencil

2 longitudinal axis

3 pencil lead

4 enveloping jacket

5 lead sharpener

6 writing end

7 lead end

8 sharpener

9 pencil guiding channel

10 channel end

11 cone-shaped jacket

12 pencil cone

13 back end

14 holding device

15 fitting-on side

16 opening for fitting on

17 sleeve

18 opening edge

19 holding side

20 holding projection

21 molded body

22 projection segments

23 projection direction

24 expanding fixation region

25 narrowing region

26 inside diameter

27 gap

1. A device for detachably connecting a pencil sharpener (8) to a pencil (1), for example a writing pencil, drawing pencil or marking pencil, which device
can be fitted detachably adhering onto a pencil from one pencil end (7, 13) in the manner of a cap or sleeve (17) that grips around the pencil shaft (4),
contains a rubber-elastic material, e.g. a plastic, or is made of a plastic material with sufficiently high friction coefficient for a frictional connection, at least with respect to its adhering surface, and
is provided with a holding projection (20) for the frictional engagement in the pencil guiding channel (9) of the sharpener (8), so as to be detachable as well
wherein the holding projection (20) contains several projection segments (22)
arranged at a distance to each other side-by-side and radial to its projection direction (23),
which project in projecting direction (23) away from the cap or sleeve (17) that is fitted on,
and which can be deflected elastically, counter to the direction of their distance relative to each other, in order to create a permanent expansion pressure.

2. A device according to claim 1, characterized in that the holding projection (20) is positioned outside of the fitting-on side (15) of the molded body (21) that forms the holding device.

3. A device according to claim 1 or 2, characterized in that the molded body (21) is molded so as to form one piece with its cap or sleeve (17) for fitting on, as well as with its holding projection (20).

4. A device according to one of the claims 1 to 3, characterized in that the cap or sleeve (17) for fitting on and the holding projection (20) are assigned to two opposite ends of the molded body (21).

5. A device according to one of the claims 1 to 4, characterized in that four projection segments (22) of equal size and preferably equal design are provided, which are positioned side-by-side in the manner of the rods for a fasces.

6. A device according to one of the preceding claims, characterized in that the fitting-on cap (17) forms a hollow space, which is sealed relative to the surrounding atmosphere in the position where the cap is fitted onto the pencil (1).

7. A device according to one of the preceding claims, characterized in that the outer periphery of the projection segments (22) represents a portion of a peripheral jacket, in particular a cylindrical covering, which concentrically surrounds the longitudinal axis of the holding projection (20).

8. A device according to one of the preceding claims, characterized in that the holding projection (20) forms a region (25), narrowed down in radial direction, between its outer expanding fixation region (24) in axial direction and its fitting-on end (15).

9. A device according to one of the preceding claims, characterized in that the inside diameter (26) of the opening (16) for fitting or sliding the holding cap or holding sleeve (17) on diverges slightly from it inner end in the direction toward the end facing the fitting-on opening.

10. A device according to one of the preceding claims, characterized in that the material for the molded body (21) is provided with the erasing properties of an eraser.
